(19) United States
(12) Patent Application Publication
(10) Pub. No.: US 2002/0178172 A1
(43) Pub. Date: Nov. 28, 2002

(54) Methods and apparatuses for application analysis and report

(76) Inventors: Amy Elizabeth Moore, Parker, CO (US); James Donovan Moore, Parker, CO (US)

Correspondence Address: HOLLAND & HART, LLP, 555 17TH STREET, SUITE 3200, DENVER, CO, 80201, US

(21) Appl. No.: 10/152,761

(22) Filed: May 22, 2002

Related U.S. Application Data
(60) Provisional application No. 60/293,296, filed on May 24, 2001.

(51) Int. Cl. G06F 7/00

(52) U.S. Cl. 707/102

(57) ABSTRACT

The present invention relates to a tool that enumerates metadata relating to financial programs. The enumerated metadata is used to generate non-standard reports relating to the financial program.

The application claims the benefit of U.S. Provisional Application Serial No. 60/293,296, filed May 24, 2001, titled “Application Analysis and Reporting Tool/System,” incorporated herein by reference.

### FIELD OF THE INVENTION

The present invention relates to analysis and reporting tools and, more particularly, an analysis and reporting tool useful for business performance management programs.

### BACKGROUND OF THE INVENTION

Business performance management programs are useful for business executives, officers, directors and managers to organize workflow and task performance. An increasing number of executives are turning to business performance management programs to assist with management of the corporation.

While business management programs are useful tools for assisting for an executive, it is often difficult for the Administrator of the program to extract the metadata information from the business management program. Frequently, consultants are required to generate their own tools to get at the metadata information based on the business performance management programs. Metadata refers to information relating to the field structure of the programs. For example, a financial program associated with the business management program will contain, for example, a database or spread sheet of accounts. Each account will have data, such as 2.73 Million Dollars, as well as characteristics, such as liability or asset. As used in this application, data refers to the stored value in the database and metadata refers to the information relating to field structure of the database itself, such as the account name or designator, the attributes of the account, such as liability or asset, etc.

Thus, it would be desirable to generate an analysis and reporting tool that provided the ability to retrieve and analyze data and generate reports.

### SUMMARY OF THE INVENTION

The foregoing and other features, utilities and advantages of the invention will be apparent from the following more particular description of a preferred embodiment of the invention as illustrated in the accompanying drawings.

To attain the advantages and in accordance with the purpose of the invention, as embodimed and broadly described herein, a method in a computer system for generating reports relating to metadata of a financial program is provided. The method comprises accessing a financial program(s) and enumerating metadata from the financial program. The enumerated metadata is downloaded and formatted to a memory of a tool. The enumerated metadata is used to populate a table associated with the tool. The metadata contained in the table is then organized and displayed to a user so the user can access information regarding the financial program.

Moreover, apparatuses consistent with the present invention comprise a processor, a memory, a display, and executable files that contain routines.

The executable file includes an enumeration routine. The enumeration routine is run by the processor to retrieve metadata that is displayed to a user.

Still other embodiments of the present invention include computer program products having a computer usable medium with computer readable code embodied therein for processing data to develop installation software wizards. The computer readable code includes modules configured to access a financial program and enumerate metadata from the financial program. The computer readable code further includes modules to store the metadata and display the enumerated metadata.

### BRIEF DESCRIPTION OF THE DRAWING

The above and other objects and advantages of the present invention will be apparent upon consideration of the following detailed description, taken in conjunction with the accompanying drawings, in which like reference characters refer to like parts throughout, and in which:

FIG. 1 is a functional block diagram of business performance software consistent with the present invention,

FIG. 2 is a functional block diagram of the application layer of the business performance software of FIG. 1;

FIG. 3 is a screen shot of a financial program consistent with the present invention;

FIG. 4 is a screen shot of another financial program consistent with the present invention;

FIG. 5 is a flowchart 500 illustrative of an analysis and reporting tool consistent with the present invention;

FIG. 6 is a flowchart 600 illustrative of the enumeration and population portion of flowchart 500 consistent with the present invention; and

FIG. 7 is a functional block diagram of a possible operating environment consistent with the present invention.

### DETAILED DESCRIPTION

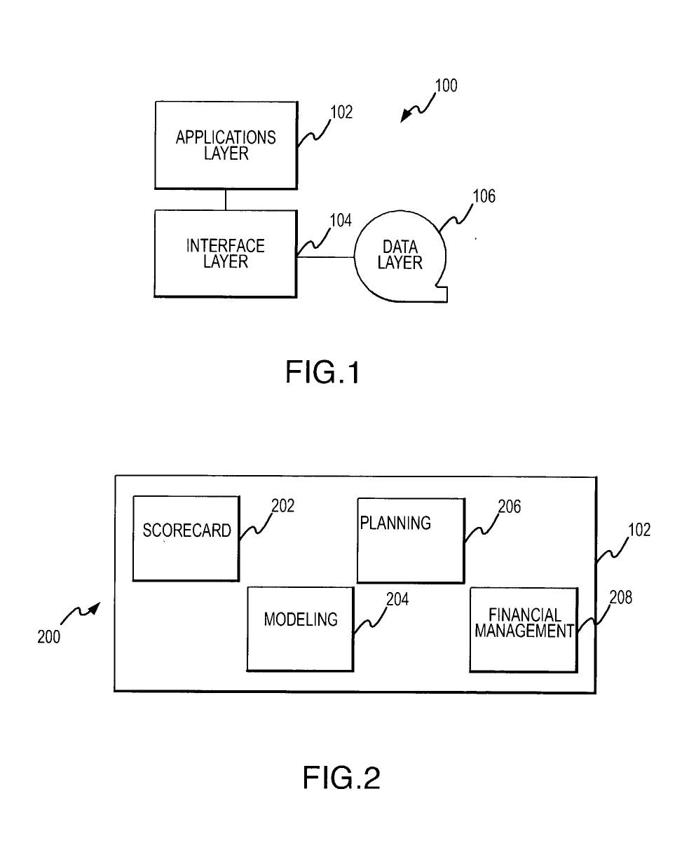

FIGS. 1-7 and the following paragraphs describe some embodiments of the present invention. Like reference characters are used wherever possible to identify like components or blocks to simplify the description of the various subcomponents described herein. More particularly, the present invention is described in relation to the business performance management by Hyperion Solutions Corporation, but one of ordinary skill in the art would understand the present invention is applicable to other complex software packages require a user generate non-standard reports by extracting metadata information from the business management program. In this application, metadata is used to distinguish between, for example, a database field and attributes about that field, from the information actually contained in that field. Further, the present invention will be described in the general context of computer-instructions being executed on a personal computer. Computer instructions, such as, for example, program modules generally include routines, programs, objects, components, and data structures, to perform particular tasks or manipulate data. Moreover, while the present invention will be described as operating on a personal computer, one of ordinary skill in the art would appreciate that the invention could be implemented on other systems, such as, multiprocessor systems, local area networks (LAN), wide-area networks (WAN), microprocessor based or programmable consumer electronics, mainframe systems, or multiple server systems. Upon reading the disclosure, one of skill in the art will now recognize that alternate and equivalent embodiments of the present invention are possible and may be made without departing from the spirit and scope of the present invention.

FIG. 1 illustrates an exemplary business performance management program architecture (PBM) 100. PBM 100 is arranged in a three tier system including a user interface tier (not specifically shown), a program tier including an applications layer 102 and an interface layer 104, and a data tier including data layer 106. Data layer 106 stores information used by PBM 100. Data layer 106 provides a comprehensive and integrated database memory that could be, for example, a consolidated database and an enterprise database on a server compatible with running and maintaining an Oracle database or some other memory structure. Typically, data layer 106 has the ability to direct write information to and from the memory.

The interface layer 104 provides an interface between data and information stored in data layer 106 and application layer 102. In other words, interface layer 104 provides a platform to quickly leverage and integrate data from multiple data sources and distribute the stored data to the user via application layer 102. Interface layer 104 frequently contains tools (not specifically shown) to provide some data manipulation.

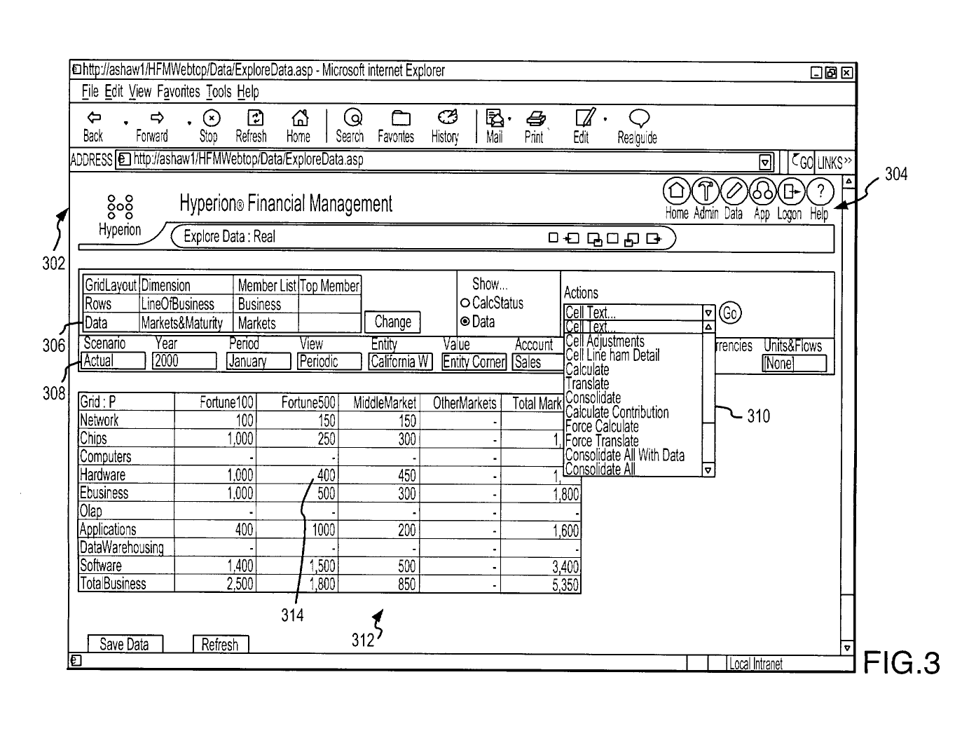

As shown in FIG. 2, application layer 102 contains the PBM computer modules 200. While the tiers can be installed on one or more servers, it can also be implemented on a user's personal computer or other processor (not specifically shown). When multiple servers are used, a load director located between the servers can be used to provide load balancing (not specifically labeled or explained in FIG. 2 for simplicity). Applications, such as a performance scorecard program 202, a business modeling program 204, a planning program 206, and a financial management program 208 could reside in application layer 102. Of course, these programs are exemplary and more, less, or different programs could be installed on the application layer 102 as a matter of design choice.

Most PBM 100 systems include at least one financial management program 208. For example, the Hyperion system provides the option of two such programs, the Hyperion Financial Management program and the Hyperion Enterprise program.

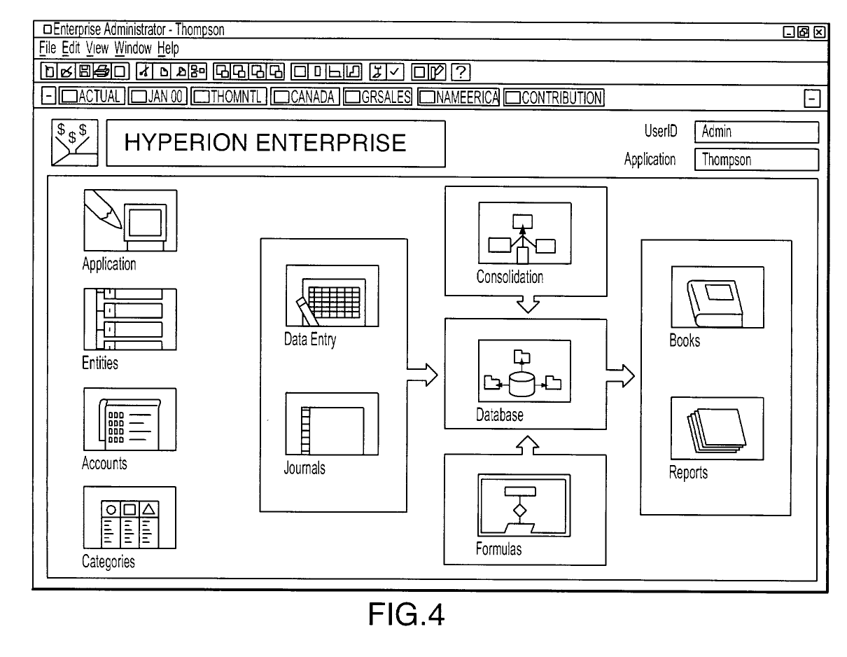

The Hyperion Financial Management program is a web-based financial package. FIG. 3 shows a sample screen shot 300 of the Hyperion Financial Management program. Screen shot 300 includes a banner 302, which includes the software package title and the data table title, links 304, which can include internal and external links to additional resources, a data layout grid 306, which in this case indicates the rows represent business and the columns indicate markets, a data period information selection line 308, which shows that the current information is selected for January 2000, an action bar 310, which indicates package standard data manipulation and report generating, and the data grid 312, which includes data cells, such as data cell 314 indicating 400 “Fortune 500” companies are in the Hardware market. Data cells 314 contain actually data, while the metadata refers to, for example, the row Hardware market.

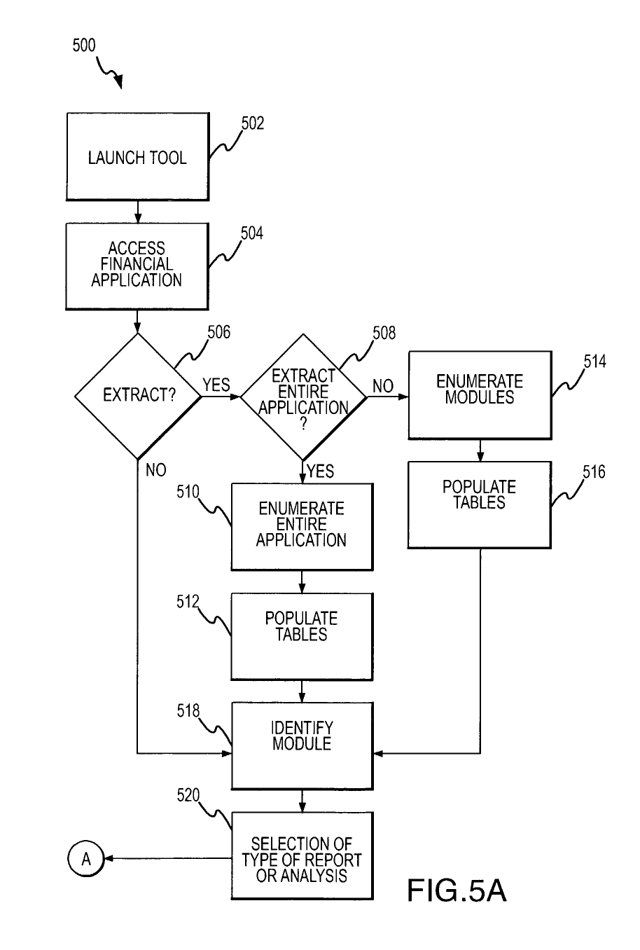

The Hyperion Enterprise program is a window-based program 400 as shown in FIG. 4. FIG. 4 shows that the Enterprise program 400 contains folders and modules. More information regarding the modules can be located in the provisional application No. 60/293,296, incorporated herein. Similar to the Hyperion Financial Management Program, the Hyperion Enterprise program provides a user with the ability to perform standard data manipulation and report generation. The Hyperion Enterprise program would also contain data fields as well as data cells within those fields. Again the metadata is the information regarding the field rather than the actual data contained in the data cell.

Both financial programs, as well as other, store information in unique ways making it difficult for administrators and advanced users to extract valuable information in non-standard reporting methodologies. For example, it is difficult to generate a report relating to account fields having the maximum-security restrictions and a specific attribute (asset or liability).

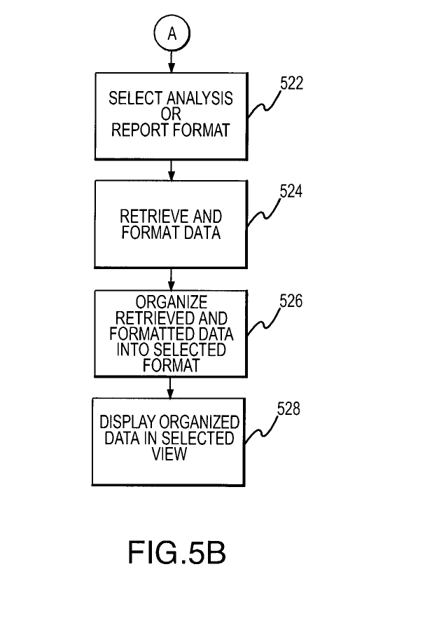

FIG. 5 shows a flowchart 500 capable of generating non-standard analysis and reports. First, you launch the analyzing and reporting tool step 502. Generally, the tool can be launched using conventional methods, such as through an executable file (which are normally designated by a .exe). Once the analyzing and reporting tool is launched, it would prompt the user to login to the financial package, step 504, which would be, for example, the Hyperion Enterprise program. Once the user has logged into the selected application, the security for the tool automatically comes from the application security. During the login, the user's processor would determine whether the financial application would need to extracted, step 506. If a user has made changes to the financial application since the financial application was last extracted, they would want to re-extract the application so it is current. For example, referring to FIG. 3, if another row or column of information is added to the displayed data grid, the tool would need to extract that information prior to running reports. The extraction process, which will be further explained below, accesses the financial applications, such as Hyperion Enterprise, and retrieves metadata relating to the changes. If extraction is necessary, it is next determined whether the entire application needs to be extracted or whether one or more modules need extraction, step 508. Determining whether the entire financial application or a particular module needs extraction generally involves how much data has changed from a previous extraction. If the entire application needs to be extracted, the entire application is enumerated and all data tables are populated, steps 510 and 512. If one or more modules need to be extracted, then those modules are enumerated and associated tables are populated, steps 514 and 516. A user may want to extract the entire financial application or a particular module, thus it would be possible to manually select extraction. The user always determines if it is necessary to re-extract all or a particular module of the application. This is setup to be in control of the user, because there are reasons to do analysis on an extract prior to recent changes.

If only a particular module needs extraction, because for instance only one module had a data change, then the modules the user can select from are going to coincide with the modules of the financial application. Notice, identifying what modules contain changes could be programmed to be done automatically. Each module will have several data tables associated with it.

The tables are populated through the extract process using Application Programming Interface (“API”) code, such as enumeration. As one of ordinary skill in the art would recognize on reading this disclosure, other business performance systems may use different API procedures or equivalent processes. This enumeration process eliminates the need to perform separate steps of extracting the application and then perform an additional parsing routine in order to populate the tables.

Enumeration also allows for greater flexibility, in that individual tables (or groups of tables) can be refreshed on demand. Additional metadata information is available only through enumeration that cannot be extracted through other processes. For example, Hyperion Enterprise has metadata relating to, for example, accounts, entities and rollups, that can only be retrieved through the enumeration process.

If the application does not need extraction, or after the application or module is extracted, the user is prompted to select from which module the user would like to run a non-standard report or analysis, step 520. For example, the user may select a security module report. After the module to be analyzed or reported on is selected, the type or data selection criteria of the non-standard report is selected, step 520. Types or possible reports are explained further below. After the non-standard report is selected, a format for the report is identified, step 522. The selected format could have a user specified sort, such as an alphanumeric order or an application order, an application order is a sort that orders items in the order they are setup in the application, a selection criterion, such as a particular security class, or a particular user's security. Finally, the format includes identifying the viewing, which could include a screen view, a print, a store, or the like.

Once the non-standard analysis and report is selected, a report generation portion of the tool selects and formats the data selected to generate the report, step 524. The reports use selection criteria to filter out the information contained in the tool's table(s) based on the user identified criteria. Using the accounts example, the report may filter the table to identify and report on accounts listed as assets. If a user is having a problem in the application where the data is incorrect, the selection criteria functionality will pinpoint the problem quickly. Currently, locating the problem would take an in-depth knowledge of the application extract file, a process to manipulate the extract and then a method to identify the information needed. The report generation portion of the tool then organizes the extracted data in the selected format, step 526, and displays the report in the specified manner, step 528.

For example, a user runs a standard financial report in Hyperion Enterprise that indicates cash assets at 5 Million USD. Knowing the cash assets of the company should only be around 1 Million USD, the user will recognize a cash accounts error occurred in the system. Currently, locating this cash account error within the metadata, would take an in-depth knowledge of the application extract file, a process to manipulate the extract and then a method to identify the information needed. Using the tool of the present invention, the tool can quickly identify all accounts with a cash asset attribute. The user can then quickly scan the non-standard report to identify, for example, an account indicating an attribute of a cash asset that should be a liability. If, for example, the incorrect account contained actual data of 2 Million USD, that would account for the 4 Million USD swing in cash assets, quickly identifying and allowing correction of the misreported cash assets.

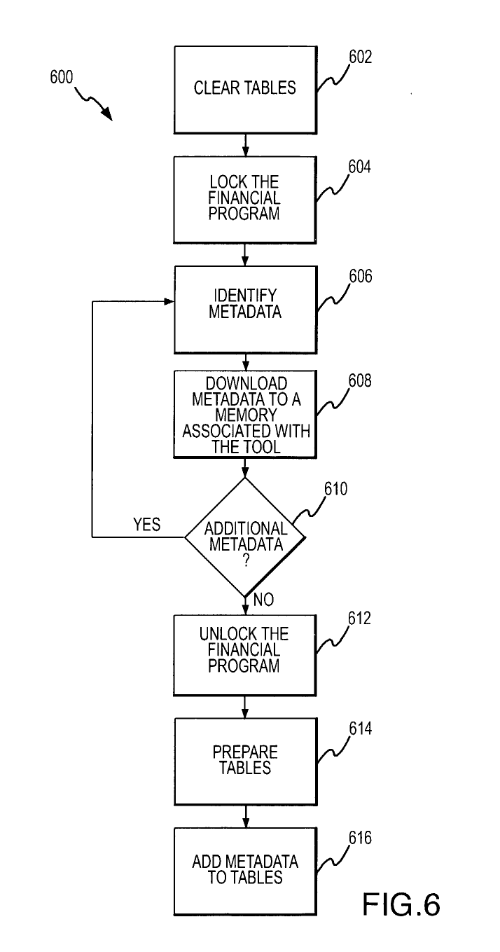

FIG. 6 is a flowchart 600 for enumeration and population of the tools tables consistent with the present invention. Flowchart 600 is described with relation to enumeration of the entire financial program, but would be similar for enumeration of one or more modules associated with the financial program. In particular, the enumeration process begins by clearing the tool's tables, step 602. Next, the financial program is locked, step 604. Locking the financial program prevents a user from changing entries during the enumeration process. The tool then identifies metadata in the financial program to populate the table(s) of the tool, step 606. The identified data is downloaded to memory associated with the tool, step 608. The information downloaded to memory could be stored, for example, in an array of information, in a cache buffer, in a conventional database, etc. The enumeration process then determines if more data is required and/or available, step 610. If more data is required and/or available, then control returns to step 606. If more data is not required and/or available, then the tool unlocks the financial program, step 612. The tool then prepares the tool table(s) for adding the new data, step 614, and adds the data to the table(s), step 616.

The enumeration process, thus, gathers the metadata to populate the table. For example, if the tool is generating a security group list, the table will contain fields to contain the metadata associated with security group list, such as for example, metadata associated with user, classes, etc. The enumeration function will then gather only the security group list metadata contained in the financial program. Thus, the non-standard report can be tailored for exactly the information the user desires.

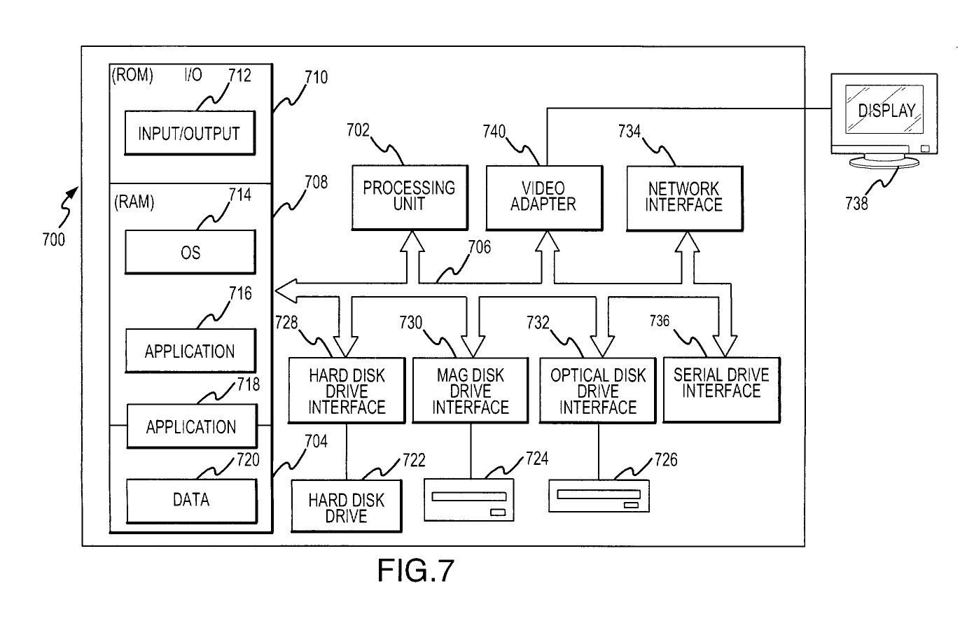

Referring to FIG. 7, the present invention could be implemented on a conventional personal computer 700, for example. Generally, personal computer 700 includes a processing unit 702, a system memory 704, and a system bus 706. System bus 706 couples the various system components and allows data to be exchanged between the components. System bus 706 could operate on any number of conventional bus protocols. System memory 704 generally comprises both a random access memory (RAM) 708 and a read only memory (ROM) 710. ROM 710 generally stores basic operating information system such as a basic input/output system (BIOS) 712. RAM 708 often contains the basic operating system (OS) 714, application software 716 and 718, and data 720. Personal computer 700 generally includes one or more of a hard disk drive 722, a magnetic disk drive 724, or an optical disk drive 726. The drives are connected to the bus 706 via a hard disk drive interface 728, a magnetic disk drive interface 730 and an optical disk drive interface 732. Application modules and data may be stored on a disk, such as, for example, hard disk installed in the hard disk drive (not shown). Personal computer 700 also may have network connection 734 to connect to a WAN, such as the World Wide Web, and/or a serial port interface 736 to connect to peripherals, such as a mouse, keyboard, modem, or printer. Personal computer may also have USB ports or wireless components, not shown. Personal computer 700 typically has a display or monitor 738 connected to bus 706 through an appropriate interface, such as a video adapter 740. One reading this disclosure, those of skill in the art will recognize that many of the components discussed as separate units may be combined into one unit and an individually unit may be split into several different units. Further, the various functions could be contained in one personal computer or spread over several networked personal computers.

An embodiment of the present invention and many of its improvements have been described with a degree of particularity. It should be understood that this description has been made by way of example, and that the invention is defined by the scope of the following claims.

We claim:

1. A method in a computer system for generating reports relating to metadata of a financial program, comprising the steps of:
accessing at least one financial program;
clearing at least one tool table;
enumerating metadata from the at least one financial program;
downloading the enumerated metadata into at least one tool memory;
formatting the downloaded metadata for storage in the at least one cleared tool table;
populating the at least one cleared tool table with the formatted metadata into at least one populated tool table;
organizing the formatted metadata in the at least one populated tool table for display to a user;
displaying the organized, formatted metadata.

2. The method of claim 1, further comprising the step of:
generating the at least one tool table such that the at least one tool table has fields relating to metadata; and
the enumerating step only retrieves metadata necessary to populate the at least one tool table.

3. The method of claim 1, further comprising the steps of:
identifying at least one module of the at least one financial package to be enumerated; and
the enumerating step only enumerates metadata from the identified at least one module.

4. The method of claim 1, wherein the enumerating step includes:
determining whether additional metadata needs to be enumerated; and
if it is determined that additional metadata needs to be enumerated, enumerating the additional metadata.

5. The method of claim 1, further comprising the steps of:
locking the at least one financial program; and
unlocking the at least one financial program,
such that locking and unlocking steps inhibit edits to the at least one financial program during the enumerating step.

6. The method of claim 1, further comprising the step of:
determining whether the at least one financial package needs to be enumerating; and
if it is determined that the at least one financial package does not need to be enumerated, skipping the enumerating step.

7. The method of claim 3, further comprising the step of:
determining whether the at least one module needs to be enumerating; and
if it is determined that the at least module does not need to be enumerated, skipping the enumerating step.

8. The method of claim 1, wherein the displaying step comprises displaying the organized, formatted metadata on at least one of a monitor, a printed report, or a stored file.

9. The method of claim 1, further comprising sorting the displayed organized, formatted metadata.

10. An apparatus for generating reports relating to metadata of a financial program, comprising:
at least one processor;
at least one memory;
at least one executable file stored in the at least one memory, the at least one executable file comprises at least an enumeration routine;
at least one tool table stored in the at least one memory, the at least one tool table comprising at least one field relating to metadata of at least one financial program;
at least one display; and
the enumeration routine is run by the at least one processor to retrieve the metadata and populate the at least one tool table, and the metadata contained in the at least one table is provided on the at least one display.

11. The apparatus of claim 10, further comprising:
a generating routine,
the generating routine generates the at least one tool table.

12. The apparatus of claim 10, wherein the at least one executable file further comprises:
an identification routine,
the identification routine selects at least one module from the at least of financial program to be enumerated.

13. The apparatus of claim 10, wherein the enumeration routine includes a subroutine to determine whether additional metadata needs to be enumerated.

14. The apparatus of claim 10, wherein the at least one executable file further comprises:
a locking routine that locks and unlocks the at least one financial program to inhibit edits to the at least one financial program during the running of the enumeration routine.

15. A computer program product comprising:
a computer usable medium having computer readable code embodied therein for processing metadata to generate reports; the computer usable medium comprising:
an accessing module configured to access at least one financial program;
a clearing module configured to clear at least one tool table;
an enumeration module configured to enumerate metadata from the at least one financial program;
a memory module configured to store metadata in the at least one cleared tool table;
a downloading module configured to download the enumerated metadata to populate the at least one cleared tool table; and
a display module configured to display the downloaded, enumerated metadata stored in the at least one populated tool table.

16. The computer program product of claim 15, further comprising:
a generating module configure to generate the at least one tool table so the at least one tool table contains fields relating to metadata.

17. The computer program product of claim 15, further comprising:
a locking module configured to lock and unlock the at least one financial program to inhibit edits to the financial program during enumeration.

18. The computer program product of claim 15, further comprising:
a selection module configured to select at least one module from the at least one financial program to be enumerated.

19. The computer program product of claim 15, further comprising:
a login module configured to allow a user to login to the at least one financial program.

20. The computer program product of claim 15, wherein the displaying module is configured to display a report on at least one of a monitor, a print report, or a storage file.
